(19) United States
(12) Patent Application Publication
(10) Pub. No.: US 2022/0110334 A1
(43) Pub. Date: Apr. 14, 2022

(54) METHOD FOR PRODUCING DOUGH FROM FLOUR AND STARCH MIXTURES

(71) Applicant: COMPAÑÍA DE GALLETAS NOEL S.A.S., Medellin (CO)

(72) Inventors: Braulio MEJÍA TEJADA, Medellín (CO); Olga Patricia LONDOÑO MORALES, Medellín (CO); Jorge Andrés GALLEGO RESTREPO, Medellín (CO); Jorge Esteban AVALOS PATIÑO, Medellín (CO); Carlos Mario MONTOYA ESTRADA, Medellín (CO)

(21) Appl. No.: 17/557,459

(22) Filed: Dec. 21, 2021

Related U.S. Application Data
(63) Continuation of application No. 16/096,181, filed on Mar. 25, 2019.

(30) Foreign Application Priority Data
Apr. 26, 2016 (CO) 16106553

(51) Int. Cl. A21D 8/02; A21D 13/16; A21D 2/18; A21D 13/04; A21D 13/06

(52) U.S. Cl. CPC A21D 8/02; A21D 13/16; A21D 2/18; A21D 10/002; A21D 13/04; A21D 13/06; A21D 2/186

(57) ABSTRACT

The invention refers to a process for obtaining dough compositions made from flour and starch having rheological characteristics that are adequate for the manufacture of food products, by mixing dry ingredients (flour, starch and additives) in determined ratios, and adding an adequate amount of water to the mix until obtaining homogenous dough. The obtained dough is of great use for the food industry.

### CROSS-REFERENCE TO RELATED APPLICATIONS

This application claims priority from and is a continuation of application Ser. No. 16/096,181 filed on Mar. 25, 2019, which is a national stage entry of PCT application serial number PCT/IB2017/052442 filed on Apr. 26, 2017, which claims priority from Colombian application serial number 16/106,553 filed on Apr. 26, 2016, which are all incorporated herein by reference in their entireties

### FIELD OF THE INVENTION

The present invention stems from the food industry, particularly from dough manufacturing processes having rheological features that are adequate for the production of food products made from a blend of flour and starch.

### DESCRIPTION OF PRIOR ART

Dough is a complex and unstable food system consisting of a polymer network of the ingredients comprising it. Dough is traditionally made from flour and starch and dough's macro structural behavior depends on its manufacturing process, its elements and the existing ratio thereof. Existing studies on rheology and dough texture define the different components' influence, allows for quality control in the final product and guides the design and any adaptation of new technologies within the process.

The processes for obtaining dough include the addition of flour, starch, gluten, seeds, additives, and water, amongst others. The ratios at which the components are added will depend greatly on the desired final product. Starch is unique among carbohydrates existing in nature in the form of granules having amorphous and semi-crystalline regions. The physical organization of these granules regarding its functionality is widely renown for its critical importance, and therefore in how food products having starch-rich formulations behave. They are insoluble in cold water given their structure is highly organized, but they absorb water as its temperature rises. This process is called gelatinization, having a great impact in processing, quality and stability of starch-based products.

Prior art describes several processes for obtaining dough having appropriate rheological characteristics from flour and starch that contain as part of their makeup the adjustment or pre-gelatinization of starch. U.S. Pat. No. 5,747,092 describes a process for obtaining baked hors d'oeuvres made from wheat and potato flour and starch that includes the pre-gelatinization under specific stirring conditions and at temperatures between 80 and 100° C. for 30 minutes wherein the starch is incorporated in the flour until forming the dough, and then laminating and cutting said dough in small portions and the baking.

US20050208191 discloses a process for preparing dough and obtaining high protein snacks obtained by roasting and milling protein-rich cereals such as wheat, roasted peanut paste, sesame seeds, soy and corn starch; dissolving the ingredients comprising the dough in an additive—(for example, vitamins) enriched hot water composition until obtaining a homogenous dough; laminating and cutting the homogenous dough using a 3 to 4 mm-diameter circular matrix; and baking the pieces obtained in the above step at a temperature of 180 to 220° C. for 4 to 6 minutes.

Although prior art discloses several processes for obtaining dough from flour and starch, it is nevertheless necessary to develop processes that improve the rheological properties of dough in comparison with other dough for the production of other laminated baked products, and that require less production times, shortening the process and avoiding steps such as pre-gelatinization or gelatinization of starch comprising the dough.

The present invention allows obtaining dough from flour and starch having adequate rheological properties for the elaboration of baked products, in less time, using less equipment and reducing costs and increasing production.

### BRIEF DESCRIPTION OF THE INVENTION

The present invention refers to a process of producing dough having rheological characteristics that are adequate for manufacturing food products comprising: mixing dry ingredients in determined proportions and adding an adequate amount of water to the mix until obtaining a homogenous dough.

### BRIEF DESCRIPTION OF THE DRAWINGS

FIG. 1. Process scheme for the production of dough from flour and starch blends of Example 1.

### DETAILED DESCRIPTION OF THE INVENTION

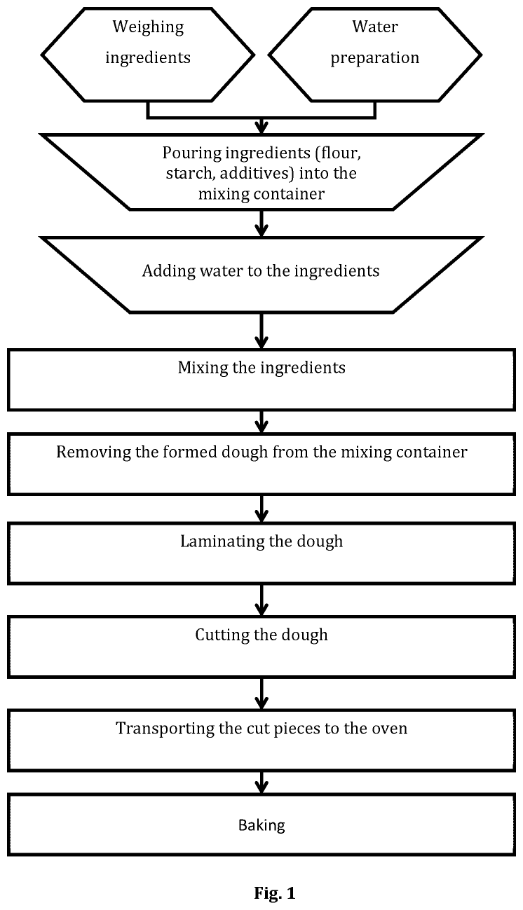

In order to obtain homogenous dough having rheological characteristics that is adequate for manufacturing food products according to the invention, dry ingredients (flour, starch and additives) must initially be mixed in determined proportions. Later, an adequate amount of water is added to the mix until obtaining homogenous dough. The homogenous dough may be laminated and cut into pieces that later can be baked until obtaining diverse products (FIG. 1).

The necessary amount of dry ingredients must be initially weighed using appropriate weighing equipment, in order to mix them in a container in such a manner that the mix contains flour between 50 and 70% w/w, starch between 30 and 50% w/w and additives between 0.01 and 10% on a dry basis. One or more types of flour with one or more types of starches and additives may be mixed. Preferably, one type of flour, two starches and several additives are mixed.

Water is added to the obtained mix and with the indicated proportions above at a temperature between 35 and 90° C. at a mix:water ratio of 1:1, 2:1, 3:1 and 4:1. The addition of water may be carried out in the same container where the mixing is done in order to facilitate handling. The container can be a mixer or kneader, which must be operated under speed and time conditions that allow obtaining a homogenous dough. The homogenous dough obtained may be subject to further steps of lamination, cutting and baking.

In a preferred embodiment of the process, water is added to the mix of ingredients at a temperature between 40° C. and 50° C. at a mix:water ratio of 3:1 in a horizontal sigma arm mixer operated at a speed ranging between 20 and 30 rpm and for 4 to 8 minutes until obtaining a homogenous dough.

For purposes of the present invention, the different types of flour are selected from the group consisting of: wheat, maize, almond, oat, pea, rye, millet, rice, soy, triticale, chickpea, bean, legume, and tuber flour and blends thereof in their different varieties. Starches are selected from the group consisting of maize, cassava, potato, sweet potato, plantain, and rice starch and starches from other tubers and combinations thereof in their different varieties.

Additives, according to the invention correspond to a set of substances that are added to the initial mix, in accordance to the flour and starch ratios, in order to improve the organoleptic and rheological properties of the dough. Amongst the additives are antioxidants, salts, spices, condiments, sugars, flavorings, fruits, colorants, cheese, leavening agents, yeasts, enzymes and dough conditioners. The final concentration of each additive varies depending of its function and the desired final product and may range between 0.01% and 10% (w/w).

The antioxidants are selected from the group comprising butylated hydroxytoluene (BHT), butylated hydroxyanisole (BHA), t-butyl hydroxyquinone (TBQH), citric acid, ascorbic acid, propyl gallate, ascorbyl palmitate, tocopherol, natural extracts having antioxidant properties and blends thereof. Furthermore, the salt is selected from the group comprising: table salt, iodide salt, marine salt, and other flavored and colored salts. Condiments and spices are selected from the group comprising: onion, pepper, tomato, cumin, basil, anise, cardamom, parsley, thymes, bay leaf, rosemary, peppermint, spearmint, sage, dill, oregano, fennel, vinegar, pepper, mustard, saffron, ginger, curcumin, cloves, wheat, flax, chia, quinoa, amaranth, corn, almond, oat, pea, rye, millet, rice, soy, triticale, and sunflower seeds, other seeds, condiments, spices and blends thereof in their different varieties.

Fruits are selected from the group consisting of: blueberries, strawberries, pineapple, bananas, kiwi, mango, orange, psidium, lulo, blackberries, and blends thereof in their different varieties. Cheese is selected from the group comprising: hard, semi-hard, semi-soft, soft, powder cheese and blends thereof.

Sugars are selected from the group comprising sweeteners, natural sweeteners, artificial sweeteners selected among refined sugar, granulated sugar, brown sugar, inverted sugar syrup, fructose, dextrose, lactose, honey, malt, polyalcohols, sorbitol, mannitol, maltitol, xylitol, isomaltitol, hydrogenated isomaltose, lactilol, polydextrose, Neotame, stevia, aspartame, erythritol, tagatose, saccharine, polyglycitol, and blends thereof. Colorants are selected from the group comprising curcumin, chlorophyl, caramel, cheese, beta carotene, carotenoids, paprika, carmine, xanthophylls, anthocyanin, lutein, red beats and blends thereof in their different varieties. Flavorings are selected from the group comprising artificial flavors, natural flavors, identical to natural flavors, extracts, and blends thereof.

Leavening agents are selected from the group comprising: monocalcium phosphate, sodium pyrophosphate acid, carbonic acid, sodium bicarbonate, ammonium bicarbonate, monopotassium phosphate salts and blends thereof. Dough conditioners are selected from the group consisting of: sodium metabisulfite, ascorbic acid, L-ascorbic acid, sodium L-ascorbate, potassium L-ascorbate, L-cystein, sorbic acid, malt flour, glutathione, azodicarbonamide, chlorine, ammonium chloride, phosphates and blends thereof.

The enzymes are selected from the group comprising proteases, xylanases, oxidases, lipases, amylases, asparaginases, in their different varieties and different origins. Yeasts are selected from the group comprising Saccharomyces cerevisiae and isolated varieties thereof under several methods and in several presentations.

The homogenous dough obtained according to the process of the invention has the composition indicated in Table 1 and characteristics indicated in Table 2.

TABLE 1

| | (% w/w) |
|---|---|
| Components | wet base |
| Flour | 30.0-45.0 |
| Starch | 15.0-30.0 |
| Water | 25.0-40.0 |
| Sugar | 0.01-3.0 |
| Salt | 0.01-1.0 |
| Seeds | 0.01-8.0 |
| Flavorings | 0.01-1.0 |
| Antioxidants | 0.001-0.05 |

TABLE 2

| Characteristics | Value |
|---|---|
| Humidity (%) | 30-38 |
| Biaxial Resistance (kPa) | 410-550 |
| pH | 5-6 |

The present invention will be presented in detail through the following examples, which are shown only for the purpose of illustration and not aimed at limiting its scope.

### EXAMPLES

### Example 1: Weighing of Dry Ingredients in a 65:35 Ratio

Flour and starch are initially weighed in a 65:35 ratio, i.e., 100 grams of wheat flour, 33 grams of yucca starch and 22 grams of potato starch is weighed, the latter characterized by a granulometry test shown in Table 3. Later, 6 grams of sugar and 1 gram of salt is weighed, which were added together with the flour and starch into a mixing container.

TABLE 3

| Granulometry | | |
|---|---|---|
| (mm) | % Retention | |
| Mesh 18 | 0.0 | max. |
| Mesh 40 | 15.0 | max. |
| Mesh 60 | 28.6-50.0 | |
| Mesh170 | 33.0 | max |

### Example 2: Weighing of Dry Ingredients in a 62:38 Ratio

Dough for food products was prepared using flour and starch in a 62:38 ratio for which 89 grams of wheat flour, 11 grams of corn flour, 33 grams of yucca starch and 31 grams of potato starch was weighed, the latter characterized by a granulometry test shown in Table 3. Subsequently, 6 grams of sugar, 1.2 grams of salt, 13 grams of seeds and grain, 0.5 grams of flavoring and 0.023 grams of antioxidants were weighed and were added together with the flour and starch into a mixing container.

### Example 3: Addition of Water in Order to Form a Homogenous Mix

The dough of Example 1 and 2, to which water was added at a temperature of 50° C., was placed in the mixing container in a 67:33 mix/water ratio in order to obtain the dough homogenization. The resulting dough is mixed at a speed of 20 rpm for 4 minutes in a horizontal sigma arm mixer until obtaining homogenous dough at a temperature of 40° C., characterized by a humidity of 34%.

### Example 4: Lamination and Cutting

The resulting homogenous dough is laminated using a set of rolls achieving a thickness of 0.9 mm. The resulting sheet is cut using an embossed cutting roll forming square pieces of 40×40 mm.

### Example 5: Baking

The cut and raw pieces are placed in a three-phase continuous oven wherein cooking is carried out continuously.

The baking process is divided in three phases, characterized by:

| Phase | Baking Temperature (° C.) | |
|---|---|---|
| First phase: Structure formation | 310 | +/−20 |
| Second phase: Product development | 300 | +/−10 |
| Third phase: Color definition | 300 | +/−30 |

Baking time: 4′ 30″

What is claimed is:

1. A process for obtaining a homogenous dough, comprising:
a) mixing flour between 50 and 70% w/w on a dry basis, starch between 30 and 50% w/w on a dry basis and additives between 0.001 and 10% w/w on a dry basis; and
b) adding water at a temperature between 35° C. to 90° C. at a mix:water ratio selected between 1:1, 2:1, 3:1, and 4:1, at a speed ranging between 20 and 30 rpm and for 4 to 8 minutes until obtaining a homogenous dough;
wherein the flour is selected from the group consisting of: wheat, maize, almond, oat, pea, rye, millet, rice, soy, triticale, chickpea, bean, and blends thereof in their different varieties;
wherein the starch is selected from the group consisting of: maize, cassava, potato, sweet potato, plantain, and rice starch and combinations thereof in their different varieties;
wherein the additives are selected from the group consisting of: salt, sugar, seeds, spices, fruits, cheese, leavening agents, yeasts, enzymes and dough conditioners, colorants, flavoring, antioxidants and combinations thereof in their different varieties;
wherein the process does not include a step of pre-gelatinization of the starch comprising the dough or a step of gelatinization of the starch comprising the dough; and
wherein the homogenous dough obtained in b) has a biaxial resistance between 410-550 kPa.

2. The process according to claim 1, wherein the homogenous dough obtained in b) has the following components:

| | (% w/w) |
|---|---|
| Components | wet base |
| Flour | 30.0-45.0 |
| Starch | 15.0-30.0 |
| Water | 25.0-40.0 |
| Sugar | 0.01-3.0 |
| Salt | 0.01-1.0 |
| Seeds | 0.01-8.0 |
| Flavorings | 0.01-1.0 |
| Antioxidants | 0.001-0.05 |

3. The process according to claim 1, wherein the homogenous dough obtained in b) has the following characteristics:
Humidity: 30-38%;
pH: 5-6.

4. The process according to claim 1, wherein the homogenous dough obtained in b) is laminated until reaching a thickness of 0.8-1.4 mm and is cut until forming pieces.

5. The process according to claim 1, wherein the homogenous dough obtained in b) is baked at a temperature between 150 and 350° C.
